(19) United States
(12) Patent Application Publication
(10) Pub. No.: US 2026/0192539 A1
(43) Pub. Date: Jul. 9, 2026

(54) WATERPROOF SOUND-TRANSMITTING SHEET AND METHOD FOR MANUFACTURING SAME

(71) Applicant: AMOGREENTECH CO., LTD., Gimpo-si, Gyeonggi-do (KR)

(72) Inventors: Chan KIM, Gimpo-si (KR); Seounghoon LEE, Gimpo-si (KR); Yunmi SO, Gimpo-si (KR)

(73) Assignee: AMOGREENTECH CO., LTD., Gimpo-si, Gyeonggi-do (KR)

(21) Appl. No.: 19/132,105

(22) PCT Filed: Nov. 22, 2023
(86) PCT No.: PCT/KR2023/018865

§ 371 Date: May 22, 2025

(30) Foreign Application Priority Data
Nov. 25, 2022 (KR) 10-2022-0160032

(51) Int. Cl. B32B 5/02; B32B 5/26; B32B 7/12; D04H 1/4282; D04H 1/4382; D04H 1/587; D04H 1/64; D04H 1/728

(52) U.S. Cl. CPC B32B 5/02; B32B 5/266; B32B 5/271; B32B 7/12; D04H 1/4282; D04H 1/43838; D04H 1/587; D04H 1/64; D04H 1/728; B32B 2250/02; B32B 2250/20; B32B 2260/021; B32B 2260/046; B32B 2262/0269; B32B 2262/0284; B32B 2307/10; B32B 2307/7265; B32B 2307/737; D10B 2331/021; D10B 2401/00; D10B 2505/00

(57) ABSTRACT

Provided is a waterproof sound-transmitting sheet including a supporting substrate and a waterproof sound-transmitting layer disposed on the supporting substrate, wherein the waterproof sound-transmitting layer includes meta-aramid fibers. In the waterproof sound-transmitting sheet, a pore size does not change significantly even in extreme environments of high and extremely low temperatures, an average pore and pore distribution are maintained generally constant, and excellent water-proofing, dust-proofing, and sound-transmitting properties can thus be maintained.

### TECHNICAL FIELD

Embodiments of the present disclosure relate to a waterproof sound-transmitting sheet and a method for manufacturing the same, and more particularly, to a waterproof sound-transmitting sheet that can maintain excellent water-proofing, dust-proofing, and sound-transmitting properties because a pore size does not change significantly and is maintained generally constant even in extreme environments of high and extremely low temperatures and a method for manufacturing the same.

### BACKGROUND ART

Recently, the use of mobile electronic devices such as portable terminals, digital cameras, and laptops is increasing day by day. Such mobile electronic devices are required to have a waterproof function because they are portably used. However, sound holes for emitting sound are formed at portions where a speaker, a microphone, etc., are installed and water or dust enters into the electronic devices through the sound holes.

Accordingly, a waterproof sound-transmitting sheet is installed at the sound holes to allow sound to pass therethrough and block water or dust. Such a waterproof sound-transmitting sheet needs to be manufactured in consideration of both waterproofness and sound transmission efficiency.

In relation to the waterproof sound-transmitting sheet, Korean Patent Publication No. 10-2010-0041839 (Apr. 22, 2010) discloses a structure formed of a polytetrafluoroethylene porous membrane. However, since the waterproof sound-transmitting membrane in the related art is formed only of a polytetrafluoroethylene porous membrane, micropores of the porous membrane are gradually increased due to impact applied from the outside, sound pressure, temperature changes, etc., as the period of use increases, resulting in the reduction of water-proofing performance.

### DISCLOSURE

### Technical Problem

The first technical object of the present disclosure is to provide a waterproof sound-transmitting sheet that can maintain excellent water-proofing, dust-proofing, and sound-transmitting properties because a pore size does not change significantly and is maintained generally constant even in extreme environments of high and extremely low temperatures.

The second technical object of the present disclosure is to provide a method for manufacturing a waterproof sound-transmitting sheet that can maintain excellent water-proofing, dust-proofing, and sound-transmitting properties because a pore size does not change significantly and is maintained generally constant even in extreme environments of high and extremely low temperatures.

### Technical Solution

In order to achieve the first technical object, the present disclosure provides a waterproof sound-transmitting sheet including: a supporting substrate; and a waterproof sound-transmitting layer disposed on the supporting substrate, wherein the waterproof sound-transmitting layer includes meta-aramid fibers.

In some embodiments, the meta-aramid fibers may be linearly bonded to each other by a thermoplastic adhesive resin. In some embodiments, a content of the thermoplastic adhesive resin may be about 2 wt % to about 10 wt % of the meta-aramid fibers. In addition, the thermoplastic adhesive resin may include a butyral-based resin or an epoxy-based resin.

In some embodiments, the waterproof sound-transmitting layer may substantially include no fluorine-based resin.

In some embodiments, a diameter of the meta-aramid fiber may be about 150 nm to about 1200 nm.

In order to achieve the second technical object, the present disclosure provides a method for manufacturing a waterproof sound-transmitting sheet, including preparing a spinning solution containing meta-aramid and a solvent; forming a waterproof sound-transmitting layer by electrospinning the spinning solution; and combining the waterproof sound-transmitting layer with a supporting substrate.

In some embodiments, a content of the meta-aramid in the spinning solution may be about 10 wt % to about 20 wt %.

In some embodiments, the spinning solution may further include an adhesive polymer. In some embodiments, a content of the adhesive polymer may be about 2 wt % to about 10 wt % based on a weight of the meta-aramid.

In some embodiments, the method for manufacturing a waterproof sound-transmitting sheet may further include, after the combining, water-repelling and oil-repelling the combined waterproof sound-transmitting layer and supporting substrate. In some embodiments, the water-repelling and oil-repelling may include coating the waterproof sound-transmitting layer and the supporting substrate with a fluorine-based water-repellent and oil-repellent agent having 6 or less carbon atoms in a repeating unit. In some embodiments, the water-repelling and oil-repelling may be performed at a pH of about 4 to about 6.5.

In some embodiments, the method for manufacturing a waterproof sound-transmitting sheet may further include, after the water-repelling and oil-repelling, thermally curing the waterproof sound-transmitting layer and the supporting substrate at a temperature of about 100° C. to about 150° C.

In some embodiments, the method for manufacturing a waterproof sound-transmitting sheet may further include, before the combining, washing the waterproof sound-transmitting layer.

### Advantageous Effects

A waterproof sound-transmitting sheet of the present disclosure can maintain excellent water-proofing, dust-proofing, and sound-transmitting properties because a pore size does not change significantly and an average pore and pore distribution are maintained generally constant even in extreme environments of high and extremely low temperatures.

### DESCRIPTION OF DRAWINGS

FIG. 1 illustrates a waterproof sound-transmitting sheet according to embodiments of the present disclosure and an appearance of an electronic device including the waterproof sound-transmitting sheet.

FIG. 2 is an exploded perspective view of the waterproof sound-transmitting sheet according to embodiments of the present disclosure.

FIG. 3 illustrates a waterproof sound-transmitting sheet according to other embodiments of the present disclosure and an appearance of an electronic device including the waterproof sound-transmitting sheet.

FIG. 4 is a flowchart illustrating a method for manufacturing the waterproof sound-transmitting sheet according to embodiments of the present disclosure.

FIG. 5 is a schematic view illustrating a method for manufacturing the waterproof sound-transmitting sheet according to embodiments of the present disclosure.

FIG. 6 is a scanning electron microscope image of meta-aramid nanofibers manufactured according to Example 1.

FIGS. 7A and 7B are scanning electron microscope images of nanofiber membranes manufactured according to Example 2 and are images before and after washing, respectively.

FIG. 8A is an image showing a contact angle of a waterproof sound-transmitting sheet manufactured according to Example 3 before a water-repellent and oil-repellent treatment, and FIG. 8B is an image showing a contact angle of the waterproof sound-transmitting sheet after the water-repellent and oil-repellent treatment.

### MODE FOR INVENTION

Hereinafter, preferred embodiments of the present disclosure are described in detail with reference to the accompanying drawings. Embodiments of the present disclosure may be modified in various other forms, and the scope of the present disclosure should not be construed as being limited by the following embodiments. The embodiments of the present disclosure are preferably construed to be provided to a person having average knowledge in the art in order to more completely describe the present disclosure. The same reference numerals always refer to the same components. In addition, various components and regions in the drawings are schematically illustrated. Accordingly, the present disclosure is not limited by the relative sizes or intervals illustrated in the accompanying drawings.

The terms ‘first’ and ‘second’ may be used for the purpose of description about various components, and the components are not limited to the terms. The terms are only used to distinguish one component from another component. For example, a first component may be named as a second component without deviating from the scope of the present disclosure, and vice versa, the second component may be named as the first component.

Terms used in this application are used only to describe specific embodiments, and are not intended to limit the present disclosure. An expression of the singular number includes an expression of the plural number unless clearly defined otherwise in the context. In this application, expressions such as “comprises” or “has” are intended to designate the presence of features, numbers, steps, operations, components, parts, or combinations thereof described in the specification, and should be understood as not excluding the presence or addition of one or more other features, numbers, operations, components, parts or combinations thereof.

Unless otherwise defined, all terms used herein, including technical and scientific terms, have the same meaning as commonly understood by a person of ordinary skill in the art to which the present disclosure pertains. In addition, it will also be understood that terms commonly used, as defined in the dictionary, should be construed as having a meaning consistent with their meaning in the context of the relevant technology and should not be construed in an excessively formal sense unless explicitly defined herein.

When certain embodiments can be differently implemented, a specific process sequence may be performed differently from an order described. For example, two processes described in succession may be substantially performed simultaneously, or may be performed in a reverse order from the order described.

In the accompanying drawings, for example, modifications of the shapes illustrated may be expected depending on manufacturing techniques and/or tolerances. Accordingly, embodiments of the present disclosure should not be construed as being limited to specific shapes of regions illustrated in the present specification, and should include, for example, changes in shapes resulting from a manufacturing process. All terms “and/or” used herein include each and every combination of the mentioned components. In addition, the term “substrate” used in this specification may refer to the substrate itself, or a stack structure including the substrate and a predetermined layer, a film, etc., formed on the surface thereof. In addition, the term “surface of the substrate” used in this specification may refer to an exposed surface of the substrate itself, or an outer surface of a predetermined layer, a film, etc., formed on the substrate.

### Waterproof Sound-Transmitting Sheet

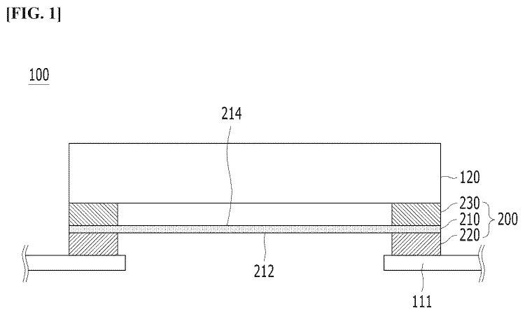

FIG. 1 illustrates a waterproof sound-transmitting sheet 200 according to embodiments of the present disclosure and an appearance of an electronic device 100 including the waterproof sound-transmitting sheet 200.

Referring to FIG. 1, the waterproof sound-transmitting sheet 200 can be attached to the inside of the electronic device 100 to prevent liquid, foreign substances, etc., flowing in from the outside of the electronic device 100 from flowing into the inside of the electronic device 100 while transmitting sound between the inside and the outside of the electronic device 100.

A first surface 212 of the waterproof sound-transmitting sheet 200 can be attached to, for example, a housing (or case) 111 of the electronic device 100, and a second surface 214 located opposite to the first surface 212 of the waterproof sound-transmitting sheet 200 can be attached to an electric element 120 inside the electronic device 100. In some embodiments, the first surface 212 of the waterproof sound-transmitting sheet 200 can be attached to an inner surface of the housing 111.

In some embodiments, the electrical element 120 may be an acoustic module such as a speaker module or a microphone module, but is not limited thereto. The acoustic module may include an acoustic element and a circuit board on which the acoustic element is mounted.

In some embodiments, the waterproof sound-transmitting sheet 200 may include a waterproof sound-transmitting layer 210 having waterproof and/or dustproof functions and configured to transmit sound, a first adhesive layer 220 configured to be attached to, for example, the housing 111 of the electronic device 100 by being attached to the first surface 212 of the waterproof sound-transmitting layer 210, and a second adhesive layer 230 configured to be attached to the electrical element 120 by being attached to the second surface 214 located opposite to the first surface 212 of the waterproof sound-transmitting layer 210.

Accordingly, the waterproof sound-transmitting sheet 200 can prevent liquid, foreign substances, etc., flowing in from the outside of the electronic device 100 from flowing into the electric element 120. In some embodiments, the waterproof sound-transmitting sheet 200 can transmit sound generated by the electric element 120 to the outside (e.g., a user) of the electronic device 100, and in this case, the electric element 120 may be a speaker module. In other embodiments, the waterproof sound-transmitting sheet 200 can transmit sound generated from the outside to the inside of the electronic device 100, and in this case, the electric element 120 may be a microphone module.

On the other hand, when the temperature inside and/or outside the electronic device 100 changes rapidly, the heat resistance and coefficient of thermal expansion (CTE) of the waterproof sound-transmitting sheet 200 have a significant influence on the stability of pores formed in the waterproof sound-transmitting sheet 200. When the coefficient of thermal expansion of the waterproof sound-transmitting sheet 200 is unnecessarily large and the heat resistance thereof is low, the pores formed in the waterproof sound-transmitting sheet 200 may be easily expanded, causing liquid, foreign substances, etc., to flow in.

The waterproof sound-transmitting sheet 200 according to the embodiments of the present disclosure can maintain excellent water-proofing, dust-proofing, and sound-transmitting properties even in extreme environments of high and extremely low temperatures. That is, meta-aramid fibers included in the waterproof sound-transmitting layer 210 of the waterproof sound-transmitting sheet 200 have a high melting point and an extremely low CTE, and thus can guarantee excellent dimensional stability. Accordingly, even though the temperature inside and/or outside the electronic device 100 changes rapidly, the size of the pores formed in the waterproof sound-transmitting layer 210 does not change significantly, and accordingly, an average pore and pore distribution can be maintained generally constant in spite of extreme temperature changes. As a result, the water-proofing, dust-proofing, and sound-transmitting properties of the waterproof sound-transmitting sheet 200 can be excellently maintained.

In addition, the surface of the meta-aramid fibers included in the waterproof sound-transmitting layer 210 may be coated with a water-repellent and oil-repellent agent. Since the meta-aramid fibers have excellent dimensional stability, the coating of the water-repellent and oil-repellent agent may be excellently maintained regardless of long-term use of the waterproof sound-transmitting sheet 200. As a result, more excellent water-proofing and dust-proofing properties may be secured.

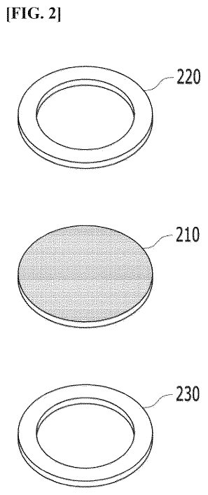

FIG. 2 is an exploded perspective view of the waterproof sound-transmitting sheet according to embodiments of the present disclosure. Referring to FIG. 2, the waterproof sound-transmitting sheet 200 may include the waterproof sound-transmitting layer 210, the first adhesive layer 220, and the second adhesive layer 230. In some embodiments, the first adhesive layer 220, the waterproof sound-transmitting layer 210, and the second adhesive layer 230 may be sequentially adhered and bonded.

The waterproof sound-transmitting layer 210 may be formed as a thin film having a predetermined shape. In some embodiments, the waterproof sound-transmitting layer 210 may be a thin film having various shapes such as a circle, an oval, and a polygon.

In some embodiments, the waterproof sound-transmitting layer 210 may have a thickness of about 5 m to about 100 m depending on the water-proofing, dust-proofing, and sound-transmitting performance required in the electronic device 100 (see FIG. 1) to which the waterproof sound-transmitting layer 210 is to be applied. However, the present disclosure is not limited thereto, and those skilled in the art will understand that the waterproof sound-transmitting layer 210 may also be formed to have a thickness of 5 μm or less or 100 μm or more in consideration of the thickness, etc., of the electronic device to which the waterproof sound-transmitting layer 210 is applied.

In some embodiments, the waterproof sound-transmitting layer 210 may include meta-aramid fibers, i.e., poly (m-phenylene isophthalamide) fibers, in order to secure dimensional stability with low CTE. The meta-aramid fibers have a low coefficient of thermal expansion of approximately 1×10⁻⁵/° C. or less and thus have significantly excellent dimensional stability compared to fluorine-based resins, such as polytetrafluoroethylene (PTFE) or polyvinylidene fluoride (PVdF), which have been widely used as waterproof sound-transmitting layers in the related art and have a relatively high coefficient of thermal expansion (approximately 10×10⁻⁵/° C. or more).

The meta-aramid fibers employed in the waterproof sound-transmitting layer 210 may be formed by electrospinning and may have a diameter of about 150 nm to about 1200 nm. When the diameter of the meta-aramid fibers is too small, the tensile strength may be insufficient. However, when the diameter of the meta-aramid fibers is too large, the processability may be poor.

The meta-aramid fibers of the waterproof sound-transmitting layer 210 may be linearly bonded to each other by a thermoplastic adhesive resin.

The thermoplastic adhesive resin may include a butyral-based resin or an epoxy-based resin. More specifically, in some embodiments, the thermoplastic adhesive resin may include an epoxy-based thermoplastic resin such as a bisphenol-A-based resin, a bisphenol-F-based resin, a cresol novolac-based resin, or a phenoxy-based epoxy resin. In some embodiments, the thermoplastic adhesive resin may include polyvinyl butyral (PVB).

In particular, the content of the thermoplastic adhesive resin may be about 2 wt % to about 10 wt % of the meta-aramid fiber. In some embodiments, the content of the thermoplastic adhesive resin may be about 2 wt % to about 10 wt %, about 3 wt % to about 9 wt %, about 4 wt % to about 8 wt %, about 5 wt % to about 7 wt % of the meta-aramid fiber, or be in a range between any two of these values.

The thermoplastic adhesive resin serves to bond the meta-aramid fibers together. In particular, the meta-aramid fibers may be bonded to each other by pre-adhesion by the thermoplastic adhesive resin. In addition, when the waterproof sound-transmitting layer 210 is attached to a supporting substrate 215 to be described below, the thermoplastic adhesive resin can contribute to firm interfacial bonding with the supporting substrate 215.

When the content of the adhesive polymer is excessively low, the adhesive component may be insufficient, resulting in insufficient adhesion between the meta-aramid nanofibers and/or insufficient interfacial adhesion between the meta-aramid nanofibers and the supporting substrate. As a result, phenomena such as detachment of the meta-aramid fibers and/or interface detachment from the supporting substrate may occur due to external pressure or aging due to long-term use. When the content of the adhesive polymer is excessively high, the pores may be blocked during a laminating process.

The waterproof sound-transmitting layer 210 may substantially include no fluorine-based resin such as PTFE or PVdF.

The first adhesive layer 220 may be formed as a thin film having a predetermined shape and having an opening therein. For example, the first adhesive layer 220 may be formed as a thin film having various shapes such as a circle, an oval, and a polygon depending on the shape of the waterproof sound-transmitting layer 210. In such a case, the first adhesive layer 220 may include an opening for sound transmission. For example, the first adhesive layer 220 may have a ring-shaped shape having an opening in the center thereof. However, the present disclosure is not limited thereto.

The first adhesive layer 220 may be adhered to the first surface 212 of the waterproof sound-transmitting layer 210. In some embodiments, a lower surface of the first adhesive layer 220 may be attached to the electronic device 100, and an upper surface of the first adhesive layer 220 opposite to the lower surface may be adhered to the first surface 212 of the waterproof sound-transmitting layer 210.

In some embodiments, the first adhesive layer 220 may be attached to a formation region of an acoustic hole formed in the electronic device 100.

The second adhesive layer 230 may be formed as a thin film having a predetermined shape and having an opening therein. For example, the second adhesive layer 230 may be formed as a thin film having various shapes such as a circle, an oval, and a polygon depending on the shape of the waterproof sound-transmitting layer 210. In such a case, the second adhesive layer 230 may include an opening for sound transmission. For example, the second adhesive layer 230 may have a ring-shaped shape having an opening in the center thereof. However, the present disclosure is not limited thereto.

The second adhesive layer 230 may be attached to the second surface 214 of the waterproof sound-transmitting layer 210. In some embodiments, an upper surface of the second adhesive layer 230 may be attached to the electrical element 120 such as an acoustic module, and a lower surface of the second adhesive layer 230 opposite to the upper surface may be attached to the second surface 214 of the waterproof sound-transmitting layer 210.

In some embodiments, when the electrical element 120 is an acoustic module, the second adhesive layer 230 may be provided around a region where sound of the acoustic module is input and output.

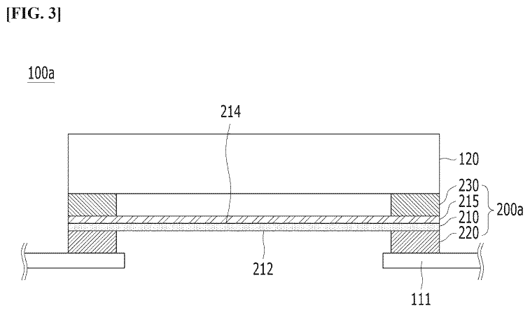

FIG. 3 illustrates a waterproof sound-transmitting sheet 200a according to other embodiments of the present disclosure and an appearance of an electronic device 100a including the waterproof sound-transmitting sheet 200a.

The waterproof sound-transmitting sheet 200a and the electronic device 100a in FIG. 3 are identical to the waterproof sound-transmitting sheet 200 and the electronic device 100 in FIG. 1 except that a supporting substrate 215 is further provided. Accordingly, the following description focuses on the supporting substrate 215 and any other overlapping descriptions are omitted.

The supporting substrate 215 may be made of a porous material formed with a plurality of pores. For example, the supporting substrate 215 may be made of a porous material formed with a plurality of pores such as a nonwoven fabric made of a material such as polyethylene terephthalate (PET), polypropylene (PP), polyethylene (PE), or nylon. For example, the supporting substrate 215 may be formed with a plurality of pores each having a size (diameter) of about 2 μm to about 20 μm. In such a case, the supporting substrate 215 may include pores sufficient to maintain an air permeability of 100 cfm or more.

In some embodiments, the supporting substrate 215 may be made of a non-porous material, but a hole for sound transmission with the electric element 120 may be formed within the supporting substrate 215. For example, the hole may be formed to penetrate upper and lower surfaces of the supporting substrate 215.

In other words, the supporting substrate 215 may be made of a porous material including a plurality of pores, or may be made of a non-porous material and may include holes through which air can communicate.

### Method for Manufacturing Waterproof Sound-Transmitting Sheet

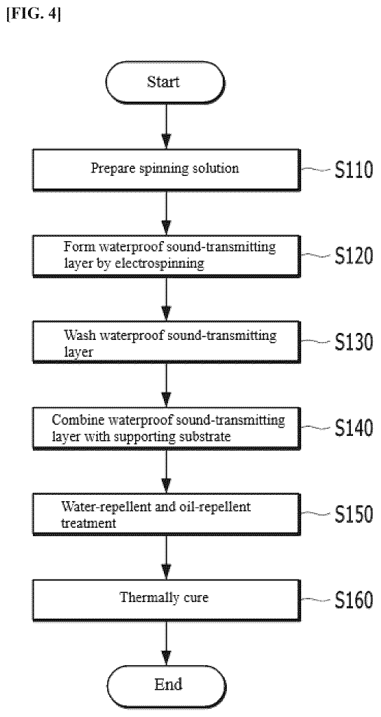

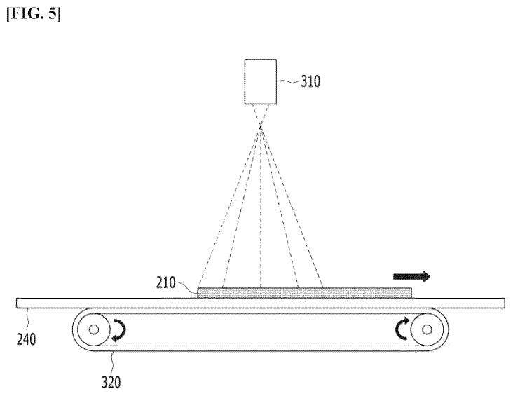

FIG. 4 is a flowchart illustrating a method for manufacturing the waterproof sound-transmitting sheet according to embodiments of the present disclosure. FIG. 5 is a schematic view illustrating a method for manufacturing the waterproof sound-transmitting sheet according to embodiments of the present disclosure.

Referring to FIGS. 4 and 5, a spinning solution containing meta-aramid and a solvent is prepared (S110).

The meta-aramid of the above spinning solution is poly (m-phenylene isophthalamide) that can be obtained by solution polymerization in a solvent using, for example, m-phenylene diamine (MPD) and isophthaloyl chloride (IPC) as monomers.

The solvent used may include, for example, N,N-dimethylacetamide (DMAc), N,N-dimethylformamide (DMF), acetone, N-methyl-2-pyrrolidone (NMP), hexamethylphosphoramide (HMPA), N,N,N′,N′-tetramethyl urea (TMU), dimethyl sulfoxide (DMSO), triethylamine (TEA), tetrahydrofuran (THF), hexafluoroisopropanol (HFIP), butylated hydroxytoluene (BHT), 1,2,4-trichlorobenzene (TCB), dimethyl carbonate (DMC), diethyl carbonate (DEC), ethyl methyl carbonate (EMC), chloroform, dichloromethane, acetic acid, formic acid, etc., but is not limited thereto.

The content of the meta-aramid in the spinning solution may be about 10 wt % to about 20 wt %. In some embodiments, the content of the meta-aramid in the spinning solution may be about 10 wt % to about 20 wt %, about 11 wt % to about 19 wt %, about 12 wt % to about 18 wt %, about 13 wt % to about 17 wt %, about 14 wt % to about 16 wt %, or be in a range between any two of these values.

When the content of the meta-aramid in the spinning solution is too low, the properties of the waterproof sound-transmitting layer 210 may deteriorate. However, when the content of the meta-aramid in the spinning solution is too high, it may be difficult to improve the properties of the waterproof sound-transmitting layer 210 due to an excessively dense structure.

In some embodiments, the spinning solution may further include an adhesive polymer. The adhesive polymer may include a thermoplastic adhesive resin having a relatively low melting point.

In some embodiments, the adhesive polymer may include a butyral-based resin or an epoxy-based resin. More specifically, in some embodiments, the adhesive polymer may include an epoxy-based thermoplastic resin such as a bisphenol-A-based resin, a bisphenol-F-based resin, a cresol novolac-based resin, or a phenoxy-based epoxy resin. In some embodiments, the adhesive polymer may include polyvinyl butyral (PVB).

In some embodiments, the content of the adhesive polymer may be about 2 wt % to about 10 wt % of the meta-aramid fiber. In some embodiments, the content of the adhesive polymer may be about 2 wt % to about 10 wt %, about 3 wt % to about 9 wt %, about 4 wt % to about 8 wt %, about 5 wt % to about 7 wt % of the meta-aramid fiber, or be in a range between any two of these values.

When the content of the adhesive polymer is excessively low, the adhesive component may be insufficient, resulting in insufficient adhesion between the meta-aramid nanofibers and/or insufficient interfacial bonding between the meta-aramid nanofibers and the supporting substrate. As a result, phenomena such as detachment of the meta-aramid fibers and/or interface detachment from the supporting substrate may occur due to external pressure or aging due to long-term use. When the content of the adhesive polymer is excessively high, the pores may be blocked during a laminating process.

In some embodiments, the viscosity of the spinning solution may be about 100 cp to about 400 cp. In some embodiments, the viscosity of the spinning solution may be about 100 cp to about 400 cp, about 120 cp to about 350 cp, about 140 cp to about 300 cp, about 160 cp to about 280 cp, about 180 cp to about 250 cp, or be in a range between any two of these values.

Referring continuously to FIGS. 4 and 5, the waterproof sound-transmitting layer 210 can be manufactured by electrospinning (S120). In some embodiments, the waterproof sound-transmitting layer 210 can be formed by spinning the spinning solution onto a collector 320 through a spinning nozzle 310.

The spinning nozzle 310 can form a nanoweb by spinning nanofibers from the spinning solution by electrospinning. In some embodiments, a hole, through which the spinning solution can flow, is formed at an end of the spinning nozzle 310. The spinning solution flowing through the hole can be discharged from the end of the spinning nozzle 310 and spun as nanofibers.

The collector 320 can be spaced apart from the bottom of the spinning nozzle 310. The collector 320 can be electrically grounded, and thus nanofibers generated from the charged spinning solution can be accumulated. That is, voltage is applied to the spinning solution flowing through the hole of the spinning nozzle 310, so that the spinning solution is charged. The charged spinning solution is discharged outside the spinning nozzle 310 in the form of nanofibers and accumulated in the electrically grounded collector 320, so that the waterproof sound-transmitting layer 210 can be formed.

In some embodiments, the collector 320 may include an electric conductor and may be implemented in the form of, for example, a metal plate or a rotating conveyor belt. In such a case, a collecting support 240 on which the waterproof sound-transmitting layer 210 is collected may be disposed on the collector 320. That is, the waterproof sound-transmitting layer 210 can be formed as fibers are accumulated on the collecting support 240 disposed on the collector 320.

The collecting support 240 may be transported on the collector 320. In some embodiments, the collecting support 240 may include a film-type non-porous member. For example, the collecting support 240 may be one of a release paper, an art paper, a coated paper, and a glossy paper. For example, a nonporous waterproof film may be coated on the formation surface of the waterproof sound-transmitting layer 210 among the surfaces of the collecting support 240.

In some embodiments, the magnitude of the voltage applied to the spinning nozzle 310 may be about 10 kV to about 105 kV, a distance between the collector 320 and a tip of the spinning nozzle 310 may be about 10 cm to about 30 cm, and the flow rate of the spinning solution spun through the spinning nozzle 310 may be about 0.01 cc/min/hole to about 0.08 cc/min/hole.

In some embodiments, the electrospinning may be performed at a temperature of about 24° C. to about 36° C. or about 28° C. to about 34° C. Preferably, the temperature may be 28° C. to 34° C. In some embodiments, the electrospinning may be performed in an environment where the relative humidity is about 30% to about 75% or about 45% to about 60%.

Subsequently, the waterproof sound-transmitting layer 210 can be washed with water (S130). In some embodiments, deionized water may be used for the washing, and the process of washing the waterproof sound-transmitting layer 210 in running water may be repeated 1 to 5 times.

Subsequently, the waterproof sound-transmitting layer 210 can be separated from the collecting support 240 and combined with the supporting substrate 215 (S140). Since the supporting substrate 215 has already been described above, a detailed description thereof is omitted.

In some embodiments, the combined waterproof sound-transmitting layer 210 and supporting substrate 215 may be subjected to a water-repellent and oil-repellent treatment (S150).

The above water-repellent and oil-repellent treatment may include, for example, a step of coating with a fluorine-based water-repellent and oil-repellent agent having 6 or less carbon atoms in the repeating unit. In some embodiments, the fluorine-based water-repellent and oil-repellent agent having 6 or less carbon atoms in the repeating unit may include polytetrafluoroethylene, polyvinylidene fluoride, polychlorotrifluoroethylene, fluorinated ethylene propylene (FEP) copolymer, poly (ethylene-co-tetrafluoro ethylene), poly (ethylene-co-chlorotrifluoro ethylene), poly (tetrafluoroethylene-co-fluoroalkyl vinyl ether), etc. However, the present disclosure is not limited thereto.

In some embodiments, the weight average molecular weight of the water-repellent and oil-repellent agent may be about 1000 to about 50000. In some embodiments, the polydispersity index (PDI) of the water-repellent and oil-repellent agent may be about 1.1 to about 2.0.

In some embodiments, the water-repellent and oil-repellent treatment can be performed using a water-repellent and oil-repellent agent further including a crosslinking agent and a catalyst in addition to the water-repellent and oil-repellent agent. In other words, the water-repellent and oil-repellent treatment can be performed by immersing the waterproof sound-transmitting layer 210 and the supporting substrate 215 in the water-repellent and oil-repellent agent for a predetermined time and then drying them at an elevated temperature.

The above elevated temperature may be about 60° C. to about 110° C. The time for immersing the waterproof sound-transmitting layer 210 and the supporting substrate 215 in the water-repellent and oil-repellent agent may be about 1 minute to about 30 minutes.

The crosslinking agent may be, for example, dimethylol dihydroxy ethylene urea (DMDHEU), and may have a range of about 1 wt % to about 10 wt % based on the total weight of the water-repellent and oil-repellent agent.

The catalyst may be, for example, MgCl₂, and may have a range of about 0.2 wt % to about 5 wt % based on the total weight of the water-repellent and oil-repellent agent.

The pH of the water-repellent and oil-repellent agent may be about 4 to about 6.5. When the pH is excessively low, the waterproof sound-transmitting layer 210 may be damaged, and when the pH is excessively high, the water-repellent and oil-repellent treatment may be insufficiently performed.

Subsequently, the waterproof sound-transmitting layer 210 and the supporting substrate 215 subjected to the water-repellent and oil-repellent treatment are thermally cured (S160). The thermal curing may be performed at a temperature of about 100° C. to about 150° C. The thermal curing can improve the adhesion between the waterproof sound-transmitting layer 210 and the supporting substrate 215 and the stability of the water-repellent and oil-repellent coating layer.

Hereinafter, the configuration and effects of the present disclosure are described in more detail with specific examples and comparative examples, but these examples are merely intended to more clearly understand the present disclosure and are not intended to limit the scope of the present disclosure.

### Example 1

m-phenylene diamine (MPD) (Sigma-Aldrich, USA) monomer and isophthaloyl chloride (IPC) (Sigma-Aldrich, USA) monomer were dissolved in a solvent to have a concentration of 15 wt %. As the solvent, dimethyl acetamide (DMAc) (Samchun, Korea) was used. The solution was stirred at 80° C. for 6 hours to obtain a spinning solution including meta-aramid.

Subsequently, the spinning solution was transferred to a spinning nozzle pack through a quantitative pump, and meta-aramid nanofibers were obtained by performing electrospinning under the conditions of a discharge rate of 0.05 cc/(g·hole) per minute, an applied voltage of 20 kV, a distance of 20 cm between a spinning nozzle and a current collector, a spinning temperature of 30° C., and a relative humidity of 60%.

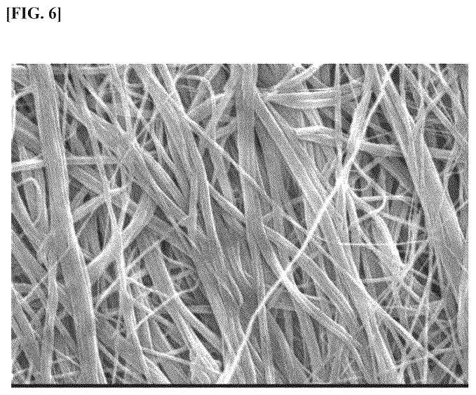

The meta-aramid nanofibers obtained in this way were washed with water three times in order to remove salt existing therein. Subsequently, the meta-aramid nanofibers were dried at 120° C. for 24 hours using a hot air dryer to obtain meta-aramid nanofibers, and surface images of the meta-aramid nanofibers were obtained using a scanning electron microscope (SEM) (see FIG. 6).

As a result of observing the surface images of the meta-aramid nanofibers, the diameters of the meta-aramid nanofibers were distributed in a range of approximately 200 nm to approximately 1000 nm, and the average diameter was approximately 300 nm.

### Example 2

An epoxy adhesive (Araldite 106, Hutsman, England) as an adhesive polymer was added to the meta-aramid polymer manufactured in the same manner as in Example 1 to have 10 wt % based on the total weight of the meta-aramid polymer and the adhesive polymer, and the amount of DMAc was adjusted, so that the concentration of the meta-aramid polymer and the adhesive polymer is 15 wt %, thereby obtaining a spinning solution.

Subsequently, electrospinning was performed under the same conditions as in Example 1, and the electrospun meta-aramid/epoxy composite nanofiber fabric was washed and dried in the same manner as in Example 1.

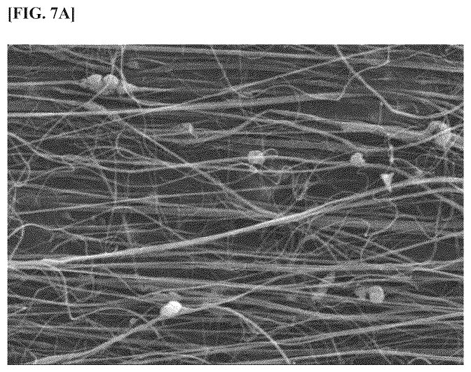

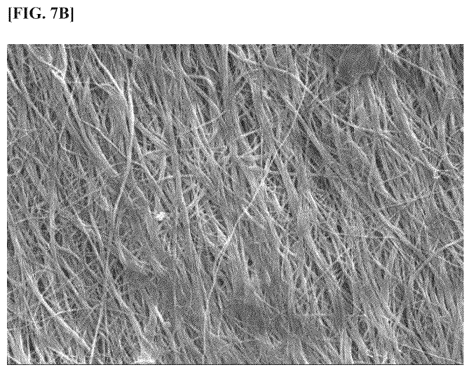

The meta-aramid/epoxy composite nanofibers manufactured in this way were subjected to thermal fusion between nanofibers through a roller heated to 120° C., so that interfacial bonding occurred between the nanofibers. As a result, a nanofiber membrane with interfacial bonding between the nanofibers was obtained by the surface thermal fusion, and an SEM image of the surface was obtained. FIG. 7A is an SEM image of the nanofiber membrane before washing, and FIG. 7B is an SEM image of the nanofiber membrane after the washing.

In addition, the components of the meta-aramid/epoxy composite nanofibers before and after the washing were analyzed by energy dispersive spectroscopy (EDS), and the analysis results are summarized in Table 1 below.

As shown in Table 1 below, it can be seen that components such as calcium and chlorine were removed by the washing.

TABLE 1

| | Before washing | | After washing | |
|---|---|---|---|---|
| Element | weight % | atom % | weight % | atom % |
| Carbon (C) | 60.15 | 76.67 | 75.00 | 80.00 |
| Oxygen (O) | 12.57 | 12.03 | 25.00 | 20.00 |
| Chlorine (C) | 17.70 | 7.67 | No detection | No detection |
| Calcium (Ca) | 9.54 | 3.64 | No detection | No detection |

### Example 3

The meta-aramid/epoxy composite nanofiber fabric manufactured in Example 2 was combined with a polyethylene terephthalate (PET) nonwoven fabric as a supporting substrate.

Subsequently, a water-repellent and oil-repellent treatment was performed on the combined composite nanofiber fabric and supporting substrate by using a fluorine-based water-repellent and oil-repellent agent.

The water-repellent and oil-repellent agent was prepared to include 5 wt % of PTFE, 5 wt % of dimethylol dihydroxy ethylene urea (DMDHEU), and 2 wt % of MgCl₂. DMDHEU was intended to serve as a crosslinker and MgCl₂ was intended to serve as a catalyst.

For the water-repellent and oil-repellent treatment, the above combined composite nanofiber fabric and supporting substrate were immersed in a treatment tank for 5 minutes, taken out, dried at 90° C. for 2 hours, and then thermally cured at 130° C. to produce a waterproof sound-transmitting sheet.

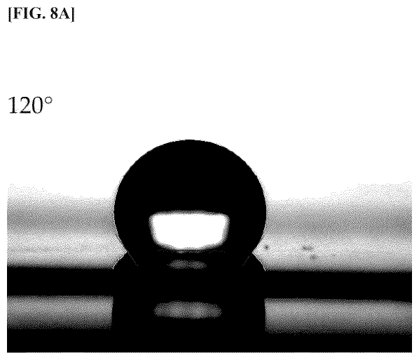

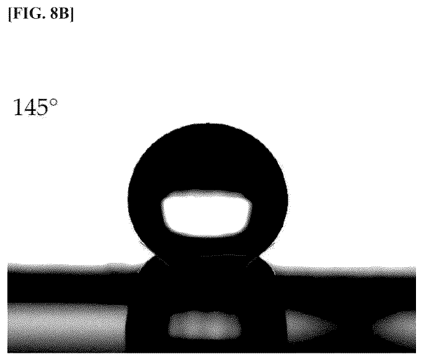

FIG. 8A is an image showing a contact angle of the waterproof sound-transmitting sheet before the water-repellent and oil-repellent treatment, and FIG. 8B is an image showing a contact angle of the waterproof sound-transmitting sheet after the water-repellent and oil-repellent treatment.

Referring to FIGS. 8A and 8B, before the water-repellent and oil-repellent treatment, the contact angle was approximately 120°, and after the water-repellent and oil-repellent treatment, the contact angle was approximately 145°. Since the contact angle increased by approximately 25°, it was confirmed that the water-repellent and oil-repellent properties were improved.

Although the embodiments of the present disclosure have been described in detail as described above, those skilled in the art will be able to modify and implement the present disclosure in various ways without departing from the spirit and scope of the present disclosure defined in the appended claims. Accordingly, changes to future embodiments of the present disclosure will not be able to depart from the technology of the present disclosure.

1. A waterproof sound-transmitting sheet comprising:
a supporting substrate; and
a waterproof sound-transmitting layer disposed on the supporting substrate, wherein the waterproof sound-transmitting layer includes meta-aramid fibers.

2. The waterproof sound-transmitting sheet of claim 1, wherein the meta-aramid fibers are linearly bonded to each other by a thermoplastic adhesive resin.

3. The waterproof sound-transmitting sheet of claim 2, wherein a content of the thermoplastic adhesive resin is 2 wt % to 10 wt % of the meta-aramid fibers.

4. The waterproof sound-transmitting sheet of claim 2, wherein the thermoplastic adhesive resin includes a butyral-based resin or an epoxy-based resin.

5. The waterproof sound-transmitting sheet of claim 1, wherein the waterproof sound-transmitting layer substantially includes no fluorine-based resin.

6. The waterproof sound-transmitting sheet of claim 1, wherein a diameter of the meta-aramid fiber is 150 nm to 1200 nm.

7. A method for manufacturing a waterproof sound-transmitting sheet, the method comprising:
preparing a spinning solution containing meta-aramid and a solvent;
forming a waterproof sound-transmitting layer by electrospinning the spinning solution; and
combining the waterproof sound-transmitting layer with a supporting substrate.

8. The method of claim 7, wherein a content of the meta-aramid in the spinning solution is 10 wt % to 20 wt %.

9. The method of claim 7, wherein the spinning solution further includes an adhesive polymer.

10. The method of claim 9, wherein a content of the adhesive polymer is 2 wt % to 10 wt % based on a weight of the meta-aramid.

11. The method of claim 7, further comprising:
after the combining, performing a water-repellent and oil-repellent treatment on the combined waterproof sound-transmitting layer and supporting substrate.

12. The method of claim 11, wherein the performing of the water-repellent and oil-repellent treatment comprises:
coating the waterproof sound-transmitting layer and the supporting substrate with a fluorine-based water-repellent and oil-repellent agent having 6 or less carbon atoms in a repeating unit.

13. The method of claim 11, wherein the performing of the water-repellent and oil-repellent treatment is performed at a pH of 4 to 6.5.

14. The method of claim 11, further comprising:
after the performing of the water-repellent and oil-repellent treatment, thermally curing the waterproof sound-transmitting layer and the supporting substrate at a temperature of 100° C. to 150° C.

15. The method of claim 7, further comprising:
before the combining, washing the waterproof sound-transmitting layer.
